(19) United States
(12) Patent Application Publication
(10) Pub. No.: US 2025/0104433 A1
(43) Pub. Date: Mar. 27, 2025

(54) INFORMATION PROVIDING METHOD AND INFORMATION PROVIDING SERVER

(71) Applicant: TOYOTA JIDOSHA KABUSHIKI KAISHA, Toyota-shi (JP)

(72) Inventors: Soma WADA, Nagoya-shi (JP); Koji NISHIGUCHI, Izumi-shi (JP)

(73) Assignee: TOYOTA JIDOSHA KABUSHIKI KAISHA, Toyota-shi (JP)

(21) Appl. No.: 18/812,493

(22) Filed: Aug. 22, 2024

(30) Foreign Application Priority Data
Sep. 25, 2023 (JP) 2023-160096

(51) Int. Cl. G06V 20/52

(52) U.S. Cl. CPC G06V 20/52; G06V 2201/07

(57) ABSTRACT

An information providing method in an information providing system is a method for providing information about a plurality of spots to a user by a server and a terminal device. Each of the plurality of spots is associated with a plurality of images that are different from one another in category. The information providing method includes: identifying a target spot from the plurality of spots (e.g., step S122, step S124); and selecting, from the plurality of images associated with the target spot, at least one image having a category in accordance with a feature of the user as an image to be presented on a display of the terminal device (e.g., step S125). Display of the spot image can be prevented from being cluttered.

### CROSS REFERENCE TO RELATED APPLICATIONS

This nonprovisional application is based on Japanese Patent Application No. 2023-160096 filed on Sep. 25, 2023 with the Japan Patent Office, the entire contents of which are hereby incorporated by reference.

### BACKGROUND

### Field

The present disclosure relates to an information providing method and an information providing server, and particularly to an information providing method for providing information about a plurality of spots to a user by a computer, and an information providing server for providing information about a plurality of spots to a user.

### Description of the Background Art

There is a conventional method for displaying a spot image associated with a spot on a map (see Japanese Patent Laying-Open No. 2019-15979, for example).

### SUMMARY

In the method of Japanese Patent Laying-Open No. 2019-15979, when spot images overlap one another, all the spot images are displayed as shown in FIGS. 6, 7, 13 and 16 of Japanese Patent Laying-Open No. 2019-15979. This results in cluttered display.

The present disclosure has been made to solve the problem described above, and an object of the present disclosure is to provide an information providing method and an information providing server capable of preventing display of a spot image from being cluttered.

An information providing method according to the present disclosure is a method for providing information about a plurality of spots to a user by a computer. Each of the plurality of spots is associated with a plurality of images that are different from one another in category. The information providing method includes: identifying a target spot from the plurality of spots; and selecting, from the plurality of images associated with the target spot, at least one image having a category in accordance with a feature of the user as an image to be presented on a display.

According to such a configuration, from the plurality of images associated with the target spot identified from the plurality of spots, at least one image having the category in accordance with the feature of the user is selected as an image to be presented on the display. As a result, an information providing method capable of preventing display of a spot image from being cluttered can be provided.

The feature of the user may be a place of residence of the user, and the image having the category in accordance with the feature of the user may be a birds-eye image of the target spot when the place of residence is located at a prescribed distance or more from the target spot, and an image other than the birds-eye image when the place of residence is located less than the prescribed distance from the target spot.

According to such a configuration, from the plurality of images associated with the target spot identified from the plurality of spots, at least one image having the category in accordance with whether or not the place of residence of the user is located at the prescribed distance or more from the target spot can be selected as an image to be presented on the display.

The feature of the user may be a viewing history by the user, and the image having the category in accordance with the feature of the user may be a birds-eye image of the target spot when a number of views of an image of the target spot is less than a prescribed number of times, and an image other than the birds-eye image when the number of views is equal to or more than the prescribed number of times.

According to such a configuration, from the plurality of images associated with the target spot identified from the plurality of spots, at least one image having the category in accordance with whether or not the number of views of the target spot by the user is equal to or more than the prescribed number of times can be selected as an image to be presented on the display.

The feature of the user may be the user's preference of a category of an image, and the category of an image may include a category of a birds-eye image and a category of a detailed image.

According to such a configuration, from the plurality of images associated with the target spot identified from the plurality of spots, at least one image having the category in accordance with the user's preference of a category of an image can be selected as an image to be presented on the display.

According to another aspect of the present disclosure, an information providing server provides information about a plurality of spots to a user. The information providing server includes: a storage unit that stores, in association with each of the plurality of spots, a plurality of images that are different from one another in category; and a processor. The processor identifies a target spot from the plurality of spots, and selects, from the plurality of images associated with the target spot, at least one image having a category in accordance with a feature of the user as an image to be presented on a display.

According to such a configuration, an information providing server capable of preventing display of a spot image from being cluttered can be provided.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram showing an overview of a configuration of an information providing system according to the present embodiment.

FIG. 2 is a flowchart showing a spot presentation process performed by a server of the information providing system in the present embodiment.

FIG. 3 is a diagram showing an exemplary database of images of spots in the present embodiment.

FIG. 4 is a diagram showing an exemplary transition of an image presented on a display of an output unit of a terminal device in the present embodiment.

### DESCRIPTION OF THE PREFERRED EMBODIMENTS

Embodiments of the present disclosure will be hereinafter described in detail with reference to the drawings, in which the same or corresponding portions are denoted by the same reference characters and description thereof will not be repeated.

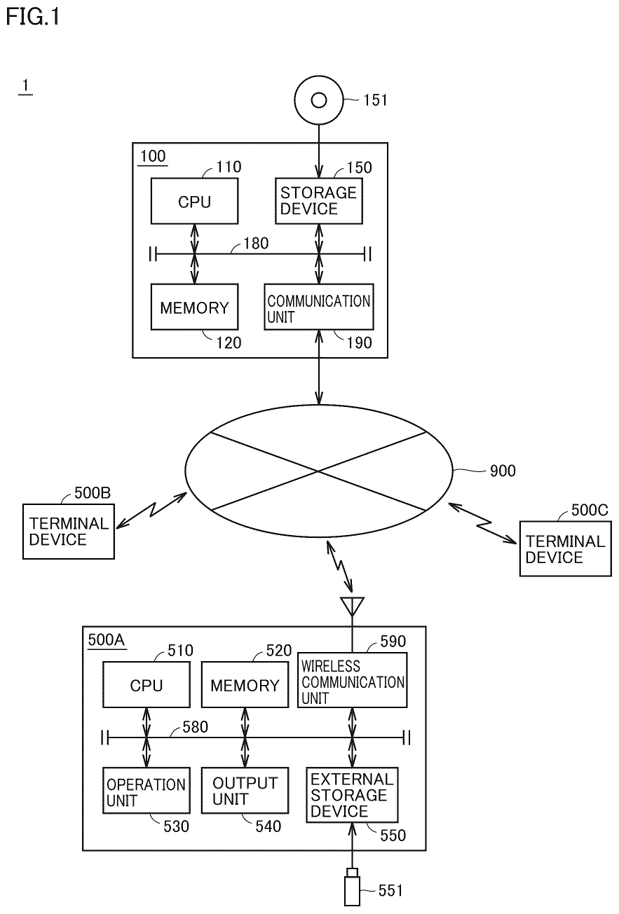

FIG. 1 is a diagram showing an overview of a configuration of an information providing system 1 according to the present embodiment. Referring to FIG. 1, information providing system 1 includes a server 100 and terminal devices 500A to 500C (hereinafter representatively referred to as a “terminal device 500”) of a plurality of users. Server 100 and terminal device 500 can communicate with each other via a communication network 900. Communication network 900 includes a private network such as a LAN (Local Area Network) or a VPN (Virtual Private Network), and a public network such as the Internet, a public circuit or a public wireless LAN.

Server 100 includes a CPU (Central Processing Unit) 110, a memory 120, a storage device 150, and a communication unit 190. CPU 110, memory 120, storage device 150, and communication unit 190 are connected to one another via a bus 180.

Memory 120 includes a RAM (Random Access Memory) used as a work area required for CPU 110 to execute a program, and a ROM (Read Only Memory) for storing a program to be executed by CPU 110. In addition, a program and data for performing prescribed processing are read from the ROM or the like and stored in the RAM.

Storage device 150 is implemented by a hard disk drive, a DVD (Digital Versatile Disk) drive, a memory card reader/writer, or the like. Storage device 150 magnetically, optically, or electrically records prescribed data or program received from CPU 110 on a recording medium 151, and reads the data or program from recording medium 151 and provides it to CPU 110. Examples of recording medium 151 include a magnetic disk such as a hard disk, an optical disk such as a DVD-ROM (Digital Versatile Disk Read Only Memory), a memory card, and a USB (Universal Serial Bus) memory.

Communication unit 190 transmits and receives data to and from an external device (e.g., terminal device 500) via communication network 900. Communication unit 190 transmits data received from a device connected to bus 180 such as CPU 110 to the outside, and provides data received from the outside to a device connected to bus 180 such as CPU 110.

CPU 110 controls memory 120, communication unit 190 and storage device 150, performs prescribed processing in accordance with a program and data stored in memory 120, processes data received from communication unit 190 and storage device 150, and causes the processed data to be stored in memory 120, to be output from communication unit 190 to another device, and to be stored in recording medium 151 of storage device 150.

While server 100 does not include an operation unit and a display unit in the present embodiment, server 100 is not limited as such and may be configured to include an operation unit and a display unit. The operation unit may include a keyboard and a mouse, and an operation signal indicative of operation content that is input to server 100 by operation of the keyboard and the mouse of the operation unit may be provided to CPU 110. The display unit may include an LCD (Liquid Crystal Display), for example, and the LCD may display an image corresponding to image data received from CPU 110.

Terminal device 500 includes a CPU 510, a memory 520, an operation unit 530, an output unit 540, an external storage device 550, and a wireless communication unit 590. CPU 510, memory 520, operation unit 530, output unit 540, external storage device 550, and wireless communication unit 590 are connected to one another via a bus 580. As CPU 510 and memory 520 are the same as CPU 110 and memory 120 of server 100, the same description will not be repeated.

External storage device 550 is implemented by a memory card reader/writer. External storage device 550 electrically records prescribed data or program received from CPU 510 on a recording medium 551 such as a memory card or a USB (Universal Serial Bus) memory, and reads the data or program from recording medium 551 and provides it to CPU 510. External storage device 550 may be implemented by a storage device such as a hard disk drive, a flexible disk drive, an MO (Magneto-Optical disk) drive, a CD (Compact Disc) drive, or a DVD (Digital Versatile Disk) drive.

Operation unit 530 includes a touch panel and operation buttons for entering numbers, alphabets and other characters, such as a telephone number and various data. Operation unit 530 may include portions for other operations. Operation of operation unit 530 by a user causes an operation signal corresponding to the operation to be transmitted from operation unit 530 to CPU 510. CPU 510 controls each unit of terminal device 500 in response to the operation signal from operation unit 530.

Wireless communication unit 590 is controlled by CPU 510 to receive, via a public circuit and an antenna, a wireless signal from another terminal device 500 or a landline telephone to which a call is being placed, convert the received wireless signal into an audio signal and transmit the converted audio signal to an audio input/output unit, and convert the audio signal from the audio input/output unit into a wireless signal and transmit, via an antenna and a communications facility of a telecommunications carrier, the wireless signal to another terminal device 500 or the landline telephone to which the call is being placed.

Wireless communication unit 590 is also controlled by CPU 510 to receive, via a public circuit and an antenna, a wireless signal from a device capable of data communication, for example, server 100 or another terminal device 500, convert the received wireless signal into data and store the converted data in memory 520 or transmit the converted data to output unit 540 in order to display the data, and convert data to be transmitted into a wireless signal and transmit, via an antenna and a communications facility of a telecommunications carrier, the wireless signal to server 100 or another terminal device 500 to which the data is to be communicated.

Wireless communication unit 590 is also controlled by CPU 510 to exchange, via a public wireless LAN or a private network wireless LAN, data with other devices capable of network communication, for example, server 100 and another terminal device 500.

Output unit 540 includes a display and a speaker. Output unit 540 is controlled by CPU 510 to display an image signal on the display as an image and output an audio signal from the speaker as sound. The image signal and the audio signal are obtained by converting, by CPU 510, information received by wireless communication unit 590, information stored in memory 520, or information read from recording medium 551 in external storage device 550.

While terminal device 500 has been described as a mobile terminal such as a smartphone, terminal device 500 is not limited as such and may be another information processing device such as a PC (Personal Computer) or a tablet.

It is conceivable to display a spot image associated with a spot on a map that is presented on the display of output unit 540 of terminal device 500 described above. Possible spots include: tourist facilities such as lodging, dining and entertainment; tourism resources including natural tourism resources such as mountains and lakes, human tourism resources such as temples, shrines and local scenery, and combined tourism resources; and local product retailers, stores, restaurants, and places where services of the service industry are available. When spot images overlap one another, it is conceivable to display all the spot images. This results in cluttered display.

Therefore, it is conceivable that each of a plurality of spots is associated with a plurality of images that are different from one another in category, and that an information providing method for providing information about a plurality of spots to a user includes: identifying a target spot from the plurality of spots; and selecting, from the plurality of images associated with the target spot, at least one image having a category in accordance with a feature of the user as an image to be presented on a display.

Thus, from the plurality of images associated with the target spot identified from the plurality of spots, at least one image having the category in accordance with the feature of the user is selected as an image to be presented on the display. As a result, display of the spot image can be prevented from being cluttered.

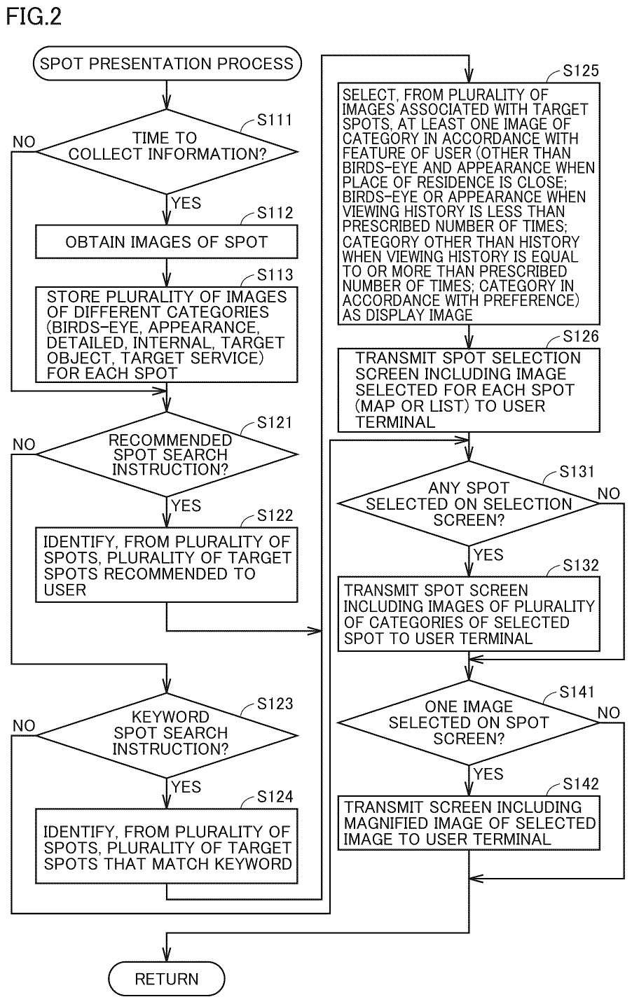

FIG. 2 is a flowchart showing a spot presentation process performed by server 100 of information providing system 1 in the present embodiment. Referring to FIG. 2, this spot presentation process is called from a higher level process and performed by CPU 110 of server 100.

CPU 110 determines whether or not it is time to collect information (e.g., a prescribed time such as 3 AM) (step S111). When it is determined that it is time to collect information (YES in step S111), CPU 110 obtains new images related to a spot from another server connected to communication network 900 or from recording medium 151 readable by storage device 150 (step S112).

Then, CPU 110 classifies the plurality of obtained images into different categories (e.g., a birds-eye image, an appearance image, a detailed image, an internal image, a target object image, and a target service image), and stores each classified image in recording medium 151 of storage device 150 as an image of a classified category for each spot corresponding to that image (step S113). The birds-eye image is an image of the spot as seen from a high angle. The appearance image is an image of the spot as seen from outside. The detailed image is an image showing details of the spot. The internal image is an image of the inside of the spot. The target object image is an image of an object sold or displayed at the spot. The target service image is an image showing service available at the spot. Note that the categories may include other categories of images.

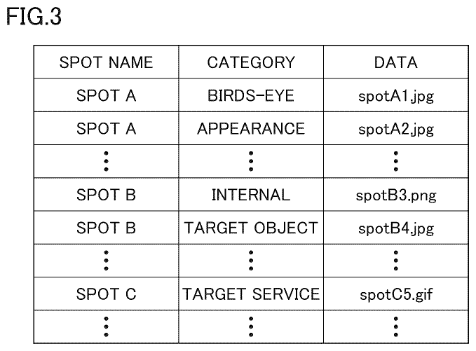

FIG. 3 is a diagram showing an exemplary database of images of spots in the present embodiment. Referring to FIG. 3, the database of images of spots stored in recording medium 151 of storage device 150 stores a name of a spot, a category of an image of the spot, and data of the image of the spot in association with one another. For example, a name of a spot “spot A,” a category of an image of the spot “birds-eye image,” and data of the image of the spot “spotA1.jpg” are stored in association with one another.

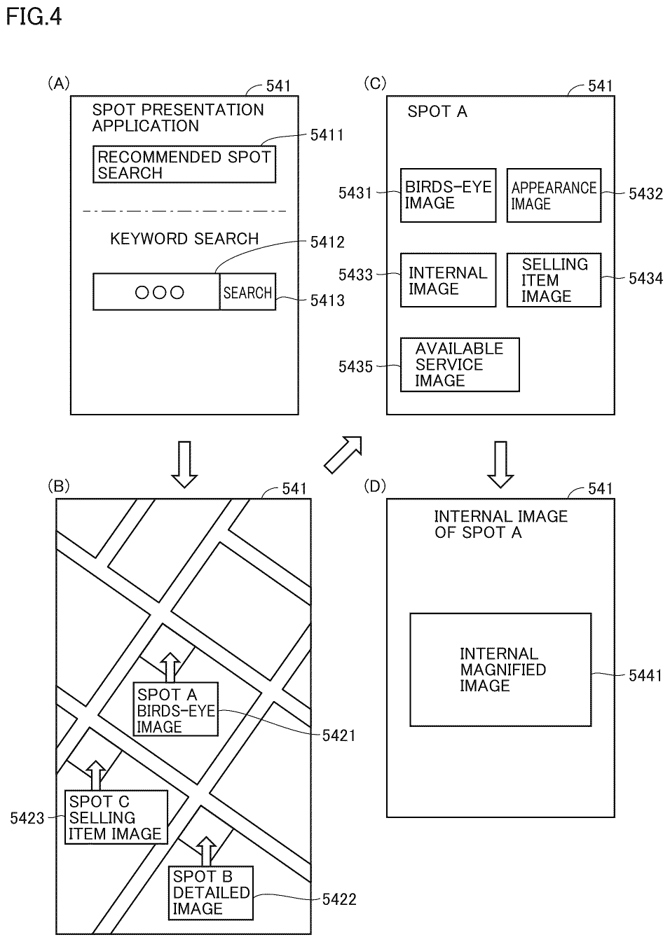

FIG. 4 is a diagram showing an exemplary transition of an image presented on a display 541 of output unit 540 of terminal device 500 in the present embodiment. Referring to FIG. 4, a search screen of a spot presentation application program (hereinafter referred to as a “spot presentation application”) is presented on display 541 as shown in FIG. 4 (A). The spot presentation application is an application program for displaying information about a spot by communicating with server 100 in terminal device 500. This search screen displays a recommended spot search button 5411 for searching for a recommended spot, as well as a search window 5412 and a search button 5413 for a keyword search.

When recommended spot search button 5411 is operated on the search screen shown in FIG. 4 (A) of the spot presentation application, the operation is detected by the touch panel of operation unit 530, and the detected operation content is transmitted from operation unit 530 to CPU 510. Upon receiving this operation content from operation unit 530, CPU 510 of terminal device 500 transmits information indicating a search for a recommended spot (hereinafter referred to as a “recommended spot search instruction”) from wireless communication unit 590 to server 100 via communication network 900.

When a keyword for a spot desired by a user is input to search window 5412 and search button 5413 is operated on the search screen shown in FIG. 4 (A) of the spot presentation application, the operation is detected by the touch panel of operation unit 530, and the detected operation content including the keyword is transmitted from operation unit 530 to CPU 510. Upon receiving this operation content from operation unit 530, CPU 510 of terminal device 500 transmits information indicating a search for a spot related to the keyword (hereinafter referred to as a “keyword spot search instruction”) from wireless communication unit 590 to server 100 via communication network 900.

Returning to FIG. 2, when it is determined that it is not time to collect information (NO in step S111), and after step S113, CPU 110 of server 100 determines whether or not the recommended spot search instruction has been received from terminal device 500 (step S121). When it is determined that the recommended spot search instruction has been received (YES in step S121), CPU 110 identifies, from the plurality of spots stored in recording medium 151 of storage device 150, a plurality of target spots recommended to the user who transmitted the recommended spot search instruction (step S122).

When it is determined that the recommended spot search instruction has not been received (NO in step S121), on the other hand, CPU 110 determines whether or not the keyword spot search instruction has been received from terminal device 500 (step S123). When it is determined that the keyword spot search instruction has been received (YES in step S123), CPU 110 identifies, from the plurality of spots stored in the database shown in FIG. 3 in recording medium 151 of storage device 150, a plurality of target spots that match the keyword indicated in the keyword spot search instruction (step S124).

After step S122 and step S124, CPU 110 selects, from the plurality of images associated with the target spots identified in step S122 or step S124 and stored in the database shown in FIG. 3 in recording medium 151 of storage device 150, at least one image of a category in accordance with a feature of the user as an image to be displayed on terminal device 500 (step S125).

The image of the category in accordance with the feature of the user with regard to the target spot is an image of a category other than the birds-eye image and the appearance image (e.g., the detailed image, the internal image, the target object image, the target service image) when the target spot is close to a place of residence of the user (e.g., the target spot is located less than a prescribed distance from the place of residence of the user). The image is the birds-eye image or the appearance image when the target spot is far away from the place of residence of the user (e.g., the target spot is located at the prescribed distance or more from the place of residence of the user). The image is the birds-eye image or the appearance image when a viewing history of the target spot by the user is less than a prescribed number of times. The image is an image of a category other than an image included in the viewing history (or an image with a large number of views) when the number of views of the target spot is equal to or more than the prescribed number of times. Alternatively, the image is an image in accordance with a preference of the user, for example, the birds-eye image when the birds-eye image is preferred by the user (e.g., when the birds-eye image is an image of a category with a larger number of views than the images of the other categories, or when the birds-eye image is an image of a preferred category that has been preset by the user).

Then, CPU 110 controls communication unit 190 to transmit, to terminal device 500 of the user, information for displaying a spot selection screen including the image selected for each spot (a screen that displays the selected images on a map, or a screen that displays the selected images in list form) (step S126).

Proceeding to FIG. 4, the spot selection screen of the spot presentation application is presented on display 541 of terminal device 500 of the user as shown in FIG. 4 (B). This selection screen displays a map, and also displays a birds-eye image 5421 of spot A at a position of spot A on the map, a detailed image 5422 of a spot B at a position of spot B on the map, and a selling item image 5423 of a spot C at a position of spot C on the map. While FIG. 4 (B) illustrates an exemplary selection screen that displays the images of the target spots on the map, the selection screen is not limited as such and may display the images of the target spots in list form or in tile form.

Returning to FIG. 2, when it is determined that the keyword spot search instruction has not been received (NO in step S123), and after step S126, CPU 110 determines whether or not any of the target spots has been selected on the selection screen transmitted to terminal device 500 in step S126 (step S131). When it is determined that any of the target spots has been selected on the selection screen (YES in step S131), CPU 110 controls communication unit 190 to transmit, to terminal device 500 of the user, a spot screen including the images of the plurality of categories associated with the selected target spot and stored in the database shown in FIG. 3 in recording medium 151 of storage device 150 (step S132). For example, when birds-eye image 5421 of spot A is selected on the selection screen, a spot screen including the images of the plurality of categories associated with spot A is transmitted to terminal device 500 of the user.

Proceeding to FIG. 4, a spot screen for spot A of the spot presentation application is presented on display 541 of terminal device 500 of the user as shown in FIG. 4 (C). This spot screen displays a birds-eye image 5431, an appearance image 5432, an internal image 5433, a selling item image 5434, and an available service image 5435 of spot A.

Returning to FIG. 2, when it is determined that any of the target spots has not been selected on the selection screen (NO in step S131), and after step S132, CPU 110 determines whether or not one image has been selected on the spot screen transmitted to terminal device 500 in step S132 (step S141). When it is determined that one image has been selected on the spot screen (YES in step S141), CPU 110 controls communication unit 190 to transmit, to terminal device 500 of the user, a screen including a magnified image of the selected image (step S142). For example, when the internal image is selected on the spot screen, a screen including a magnified image of the internal image is transmitted to terminal device 500 of the user.

Proceeding to FIG. 4, a screen including a magnified image 5441 of the internal image of spot A of the spot presentation application is presented on display 541 of terminal device 500 of the user as shown in FIG. 4 (D).

Returning to FIG. 2, when it is determined that one image has not been selected on the spot screen (NO in step S141), and after step S142, CPU 110 returns the process to be performed to the higher level process from which this spot presentation process was called.

### [Modifications]

(1) An image of a spot of a building may include an image of a spot such as a store or a restaurant occupying the building as an image in a parent-child relationship, specifically, as an image of a category other than the birds-eye image or the appearance image, for example, an image of the category of the detailed image, of the spot of the building. An image of a spot of a facility may include an image of a spot such as a store or a restaurant in the facility as an image in a parent-child relationship, specifically, as an image of a category other than the birds-eye image or the appearance image, for example, an image of the category of the detailed image, of the spot of the facility. An image of a spot of a tourism resource may include an image of a spot such as a store or a restaurant in the area of the tourism resource as an image in a parent-child relationship, specifically, as an image of a category other than the birds-eye image or the appearance image, for example, an image of the category of the detailed image, of the spot of the tourism resource. In other words, an image of a parent spot may include an image of a child spot as an image of the category of the detailed image.
(2) When a search is conducted for both a parent spot and a child spot of the parent spot in step S122 and step S124 of FIG. 2, at least one image of a category in accordance with a feature of the user may be selected as a display image from both the images of the parent spot and the images of the child spot in step S125. In this case, the image of the category in accordance with the feature of the user with regard to the target spot is an image of a category other than the birds-eye image and the appearance image of the parent spot (e.g., the detailed image, the internal image, the target object image, the target service image of the parent spot or the child spot, or the birds-eye image and the appearance image of the child spot) when the parent spot is close to the place of residence (e.g., the parent spot is located less than a prescribed distance from the place of residence of the user). The image is the birds-eye image or the appearance image of the parent spot when the parent spot is far away from the place of residence of the user (e.g., the parent spot is located at the prescribed distance or more from the place of residence of the user). The image is the birds-eye image or the appearance image of the parent spot when a viewing history of the parent spot by the user is less than a prescribed number of times. The image is an image of a category other than an image included in the viewing history (or an image with a large number of views) of the parent spot or the child spot when the number of views of the parent spot is equal to or more than the prescribed number of times. Alternatively, the image is an image in accordance with a preference of the user, for example, the birds-eye image of the parent spot when the birds-eye image is preferred by the user (e.g., when the birds-eye image is an image of a category with a larger number of views than the images of the other categories, or when the birds-eye image is an image of a preferred category that has been preset by the user).
(3) In the embodiment described above, the plurality of obtained images are classified into different categories, as shown in step S113 of FIG. 2. This classification may be performed through AI (Artificial Intelligence), or manually. When an image of a parent spot is to include an image of a child spot, if the parent spot and a certain spot are within a very short distance from each other, the certain spot may be treated as a child spot of the parent spot, and an image of the child spot may be classified as the detailed image of the parent spot. When an image of a parent spot is to include an image of a child spot, if the parent spot and a certain spot have similar names (e.g., when a parent spot is an XX shopping mall, and a certain spot has a name including the name of the parent spot, such as a “YY restaurant in XX shopping mall”), the certain spot may be treated as a child spot of the parent spot, and an image of the child spot may be classified as the detailed image of the parent spot.
(4) In the embodiment described above, a single image is displayed for each spot as shown in FIG. 4 (B). However, the display is not limited as such, and a plurality of images may be displayed for each spot to the extent that the display is not cluttered. In this case, the plurality of images are desirably displayed in such a way that they are not superimposed on one another.
(5) The foregoing disclosure can be considered as disclosure of information providing system 1, an information providing server such as server 100, or an information processing device such as terminal device 500, as shown in FIG. 1; can be considered as disclosure of an information providing method performed by an information providing server and an information processing device in information providing system 1; can be considered as disclosure of an information providing program executed by an information providing server or an information processing device; and can be considered as disclosure of computer-readable recording media 151 and 551 having an information providing program recorded thereon, as shown in FIG. 2.

### Conclusion

(1) As shown in FIGS. 1 and 2, the information providing method in information providing system 1 is a method for providing information about a plurality of spots to a user by server 100 and terminal device 500. As shown in FIG. 3, each of a plurality of spots is associated with a plurality of images that are different from one another in category. As shown in FIGS. 2 and 4, the information providing method includes: identifying a target spot from the plurality of spots (e.g., step S122, step S124); and selecting, from the plurality of images associated with the target spot, at least one image having a category in accordance with a feature of the user as an image to be presented on display 541 of terminal device 500 (e.g., step S125).

Thus, from the plurality of images associated with the target spot identified from the plurality of spots, at least one image having the category in accordance with the feature of the user is selected as an image to be presented on display 541. As a result, display of the spot image can be prevented from being cluttered.
(2) As shown in step S125 of FIG. 2, the feature of the user may be a place of residence of the user, and the image having the category in accordance with the feature of the user may be a birds-eye image or an appearance image of the target spot when the place of residence is located at a prescribed distance or more from the target spot, and an image other than the birds-eye image and the appearance image when the place of residence is located less than the prescribed distance from the target spot.

Thus, from the plurality of images associated with the target spot identified from the plurality of spots, at least one image having the category in accordance with whether or not the place of residence of the user is located at the prescribed distance or more from the target spot can be selected as an image to be presented on display 541. In addition, display of the familiar birds-eye image or appearance image can be avoided.
(3) As shown in step S125 of FIG. 2, the feature of the user may be a viewing history by the user, and the image having the category in accordance with the feature of the user may be a birds-eye image or an appearance image of the target spot when a number of views of an image of the target spot is less than a prescribed number of times, and an image other than the birds-eye image and the appearance image when the number of views is equal to or more than the prescribed number of times.

Thus, from the plurality of images associated with the target spot identified from the plurality of spots, at least one image having the category in accordance with whether or not the number of views of the target spot by the user is equal to or more than the prescribed number of times can be selected as an image to be presented on display 541. Display of the birds-eye image or the appearance image that was viewed many times can be avoided.
(4) As shown in step S125 of FIG. 2, the feature of the user may be the user's preference of a category of an image, and the category of an image may include a category of a birds-eye image and a category of a detailed image.

Thus, from the plurality of images associated with the target spot identified from the plurality of spots, at least one image having the category in accordance with the user's preference of a category of an image can be selected as an image to be presented on display 541. In addition, the image desired by the user for the target spot can be displayed.

Although the embodiments of the present disclosure have been described, it should be understood that the embodiments disclosed herein are illustrative and non-restrictive in every respect. The scope of the present disclosure is defined by the terms of the claims and is intended to include any modifications within the scope and meaning equivalent to the terms of the claims.

What is claimed is:

1. An information providing method for providing information about a plurality of spots to a user by a computer,
each of the plurality of spots being associated with a plurality of images that are different from one another in category,
the information providing method comprising:
identifying a target spot from the plurality of spots; and
selecting, from the plurality of images associated with the target spot, at least one image having a category in accordance with a feature of the user as an image to be presented on a display.

2. The information providing method according to claim 1, wherein
the feature of the user is a place of residence of the user, and
the image having the category in accordance with the feature of the user is a birds-eye image of the target spot when the place of residence is located at a prescribed distance or more from the target spot, and an image other than the birds-eye image when the place of residence is located less than the prescribed distance from the target spot.

3. The information providing method according to claim 1, wherein
the feature of the user is a viewing history by the user, and
the image having the category in accordance with the feature of the user is a birds-eye image of the target spot when a number of views of an image of the target spot is less than a prescribed number of times, and an image other than the birds-eye image when the number of views is equal to or more than the prescribed number of times.

4. The information providing method according to claim 1, wherein
the feature of the user is the user's preference of a category of an image, and
the category of an image includes a category of a birds-eye image and a category of a detailed image.

5. An information providing server for providing information about a plurality of spots to a user, the information providing server comprising:
a storage unit that stores, in association with each of the plurality of spots, a plurality of images that are different from one another in category; and
a processor, wherein
the processor
identifies a target spot from the plurality of spots, and
selects, from the plurality of images associated with the target spot, at least one image having a category in accordance with a feature of the user as an image to be presented on a display.
